(19) United States
(12) Patent Application Publication
(10) Pub. No.: US 2024/0162791 A1
(43) Pub. Date: May 16, 2024

(54) Sensor System

(71) Applicant: SICK AG, Waldkirch (DE)

(72) Inventors: David HOPP, Donaueschingen (DE); Stefan HOGG, Villingendorf (DE)

(21) Appl. No.: 18/387,874

(22) Filed: Nov. 8, 2023

(30) Foreign Application Priority Data
Nov. 16, 2022 (DE) 102022130278.4

(51) Int. Cl. H02K 11/35; H02K 11/21

(52) U.S. Cl. CPC H02K 11/35; H02K 11/21

(57) ABSTRACT

A sensor system for monitoring a motor that drives a machine arrangement via a rotating motor shaft, wherein a machine cycle is given by a periodic movement pattern of the machine arrangement and/or of the motor shaft, comprises an acceleration sensor for detecting an acceleration of the motor; and an electronic control unit that is in signal connection with the acceleration sensor and that is configured to carry out a comparison of the detected acceleration with at least one predefined threshold value for a wear recognition and to consider the machine cycle in the comparison. The electronic control unit is configured to automatically recognize the machine cycle based on a periodically occurring pattern in the time development of the detected acceleration of the motor.

The invention relates to a sensor system for monitoring a motor that drives a machine arrangement via a rotating motor shaft, wherein a machine cycle is given by a periodic movement pattern of the machine arrangement and/or of the motor shaft and the sensor system comprises the following:
at least one acceleration sensor for continuously or intermittently detecting an acceleration of the motor; and
an electronic control unit that is in signal connection with the at least one acceleration sensor and that is configured, for a wear recognition, to carry out a comparison of the detected acceleration with at least one predefined threshold value and to consider the machine cycle in the comparison.

The monitoring of motors is significant in many areas of technology. For example, in automation technology there are applications with a plurality or even a large number of motors that should not fail if possible. A wear recognition enables a failure prediction so that a repair or a replacement can take place in good time. The availability of the machine arrangement is improved by such a predictive maintenance. High accelerations, such as those that occur during vibrations and impacts, are often signs of existing wear so that a reliable wear recognition is generally possible by means of an acceleration sensor.

The application-dependent machine cycle results in different acceleration values over time. Without considering the machine cycle, the comparison of the detected acceleration with the threshold value is only of limited significance since the result of the comparison depends on the detection point in time within the machine cycle. A consideration of the machine cycle in the comparison can take place by putting the threshold value in relation to the machine cycle, i.e., for example, by comparing the respective acceleration value acquired at the beginning or in the middle of the machine cycle with the threshold value. A consideration of the machine cycle in the comparison between the detected acceleration and the threshold value can also take place by selecting the threshold value in dependence on a position of the current acceleration within the machine cycle and/or by masking the frequency of the machine cycle in a vibration frequency analysis.

The machine cycle can, for example, be predefined by the programmed machine control and can be taken therefrom during the putting into operation of the plant. Alternatively, the machine cycle can be taught by means of a “teaching” procedure. However, both involve considerable effort for the operator of the machine arrangement that is moreover incurred again when the machine cycle is changed.

It is an object of the invention to enable a simplified use of wear-recognizing sensor systems without impairing the reliability of the wear recognition.

According to the invention, the electronic control unit is configured to automatically recognize the machine cycle based on a periodically occurring pattern in the time development of the detected acceleration of the motor.

The machine cycle therefore does not have to be predefined or programmed for the evaluation of the sensor information. No intervention by the operator is required so that the putting into operation of the machine arrangement—even if the configuration is changed—can take place particularly quickly. Furthermore, input errors or teach-in errors are avoided. The recognition of the machine cycle based on the acceleration values—to be measured anyway—is simple and cost-effective. The automatically recognized machine cycle can furthermore be used for an extended wear recognition. For example, a plurality of acquired acceleration values can be compared with individual threshold values that are each predefined in dependence on the position of the acceleration value within the automatically recognized machine cycle.

Depending on the design and attachment, the acceleration to be detected by the acceleration sensor can be an axial, radial or rotational acceleration with respect to the motor shaft. Depending on the application, when comparing the detected acceleration with the threshold value, it can be checked whether the acceleration—e.g. as a result of vibrations—exceeds a threshold value, whether the acceleration 10—e.g. as a result of increased friction—falls below a threshold value, or whether a negative acceleration value falls below a threshold value as a result of impacts or friction. For this text in general, it therefore means that the acceleration value is checked against an appropriately selected threshold value.

The information density can be set to a desired value via the sampling rate of the acceleration sensor.

The acceleration sensor can be designed as a strain gauge, as a micro-electro-mechanical system (MEMS), or as a gyroscope. Furthermore, the acceleration sensor can be designed for a single-axis or multi-axis detection, depending on the application.

The sensor system preferably comprises a rotary encoder for continuously or intermittently detecting the angular position of the motor shaft. Such rotary encoders are often used for motor feedback systems.

The at least one acceleration sensor can then be fastened to a component of the rotary encoder, for example. Movements due to wear are transmitted from the machine arrangement and/or the motor to the rotary encoder so that they can be detected by the acceleration sensor installed at or in the rotary encoder. For example, the at least one acceleration sensor can be attached in a housing of the rotary encoder, for example to a circuit board of the rotary encoder that is provided anyway, which is particularly favorable with regard to the available installation space.

A particularly advantageous embodiment of the invention provides that the at least one acceleration sensor and the electronic control unit are integrated into the rotary encoder. This gives the rotary encoder the possibility to also recognize the machine cycle in addition to information regarding regular motor operation, such as the rotational speed, and to output information relating to the machine cycle, if necessary. Accordingly, the rotary encoder is provided with an extended functionality.

The at least one acceleration sensor could generally also be configured for fastening to a component of the motor, for example to the stator or the housing, in order to register their vibrations, for example.

The electronic control unit can be configured to carry out an autocorrelation of the time development of the detected acceleration for an automatic recognition of the machine cycle. By means of an autocorrelation algorithm, the self-similarity of the acceleration values in the time development can be recognized. This enables the identification of regularly recurring events as they underlie the machine cycle. Autocorrelation algorithms are relatively easy to implement.

According to a further embodiment of the invention, the electronic control unit is configured to store the machine cycle in a memory after the automatic recognition of the machine cycle so that said machine cycle is accessible for a further analysis.

The electronic control unit can be configured to output a maintenance and/or warning signal if the acceleration exceeds (or, in a corresponding embodiment, falls below as described above) the at least one threshold value. In this way, it is possible to carry out maintenance, a repair or an assembly replacement before the wear reaches a critical level. Thus, unwanted downtimes of the machine arrangement can be avoided.

A further embodiment of the invention provides that the electronic control unit is configured to define the at least one threshold value in dependence on the automatically recognized machine cycle, in particular during the putting into operation of the sensor system. If, for example, the machine cycle has a relatively high deflection at a certain position, a comparatively large threshold value is preferably also defined for this position since otherwise a wear recognition could occur even without actual wear. Similarly, a low threshold value can be defined if the machine cycle has only a small deflection at the position in question.

The electronic control unit can be configured to carry out the automatic recognition of the machine cycle repeatedly or continuously. Changes in the machine cycle can thereby be considered.

Furthermore, the electronic control unit can be configured to recognize changes in the machine cycle over time. This can, for example, be effected by comparing the currently determined machine cycle with a stored previous machine cycle.

According to a further embodiment of the invention, the electronic control unit is configured to determine at least one piece of information relating to the machine cycle, such as the length of the machine cycle, the maximum acceleration within the machine cycle and/or the number of extreme values within the machine cycle. The functionality of the sensor system is thereby extended. The information relating to the machine cycle can be output to a control unit associated with the machine arrangement.

The electronic control unit can be configured to associate the detected acceleration of the motor with a respective simultaneously detected angular position of the motor shaft. The development of the acceleration in dependence on the angular position of the motor shaft can be analyzed, stored and, if necessary, output to an external control.

A specific embodiment of the invention provides that the electronic control unit is configured to define a plurality of threshold values that are associated with respective points in time within the automatically detected machine cycle, and to carry out a separate comparison for each threshold value. This enables a more complex and more accurate wear recognition. The wear recognition can generally also be based on a threshold value that runs continuously over the machine cycle.

The invention also relates to a method for monitoring a motor that drives a machine arrangement via a rotating motor shaft, wherein a machine cycle is given by a periodic movement pattern of the machine arrangement and of the motor shaft and, in the method,
by means of at least one acceleration sensor, an acceleration of the motor is continuously or intermittently detected, and
by means of an electronic control unit, which is in signal connection with the at least one acceleration sensor, a comparison of the detected acceleration with at least one predefined threshold value is carried out for a wear recognition and the machine cycle is considered in the comparison.

To satisfy the above object, according to the invention, the machine cycle is automatically recognized based on a periodically occurring pattern in the time development of the detected acceleration of the motor.

In a method according to the invention, the angular position of the motor shaft is preferably continuously or intermittently detected by means of a rotary encoder.

The method according to the invention can furthermore comprise steps that correspond to features indicated above in connection with a sensor system according to the invention.

Further developments of the invention can also be seen from the dependent claims, from the following description, and from the enclosed drawings.

The invention will be described in the following by way of example with reference to the drawings.

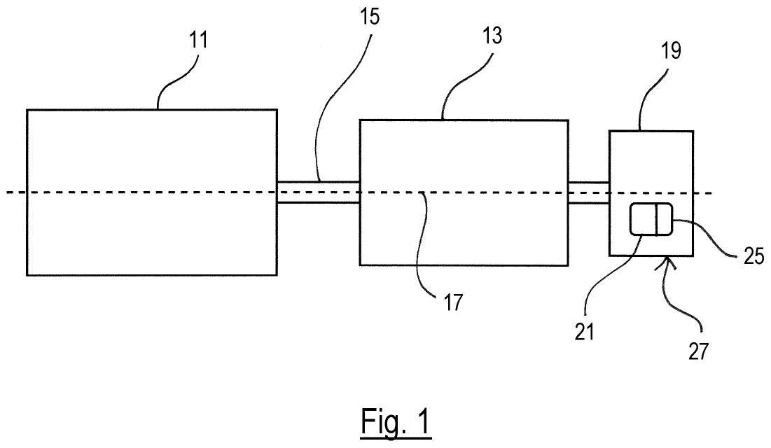

FIG. 1 shows, in schematic form, a machine arrangement, a motor for driving the machine arrangement, and a sensor system according to the invention for monitoring the motor; and

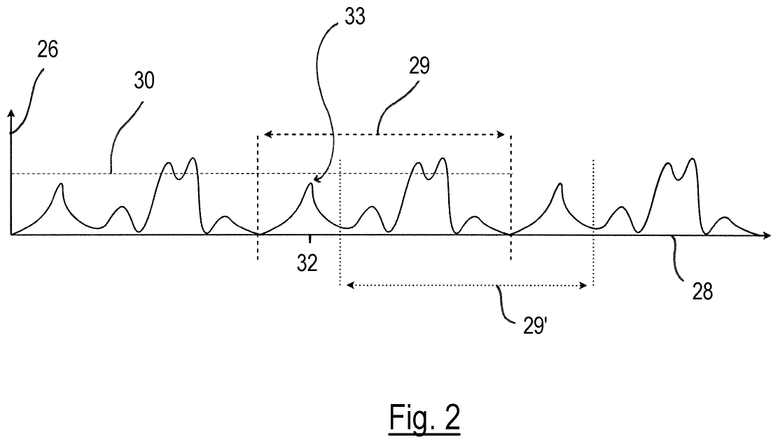

FIG. 2 is a diagram that shows an acceleration of the motor shown in FIG. 1 in dependence on the time.

FIG. 1 shows a machine arrangement 11, which can, for example, be a product conveying system, a processing machine or an automatic handling apparatus, and a motor 13 for driving the machine arrangement 11. The motor 13 is designed as an electric motor, for example as a servo motor. Furthermore, the motor 13 has a motor shaft 15 that rotates about an axis of rotation 17 during operation. The motor shaft 15 is drive-effectively coupled to an input shaft, not shown, of the machine arrangement 11.

An angle measurement system in the form of a rotary encoder 19 coupled to the motor shaft 15 is provided to continuously or intermittently detect the angular position of the motor shaft 15 during the operation of the motor 13 and, possibly based thereon, to determine a current rotational speed of the motor 13 and/or a number of revolutions of the motor shaft 15 that have occurred so far. The rotary encoder 19 can be designed as an optical or magnetic incremental encoder, as is generally known. Designs of the rotary encoder with other operating principles, such as capacitive or inductive, are likewise possible.

An acceleration sensor 21 is arranged at the rotary encoder 19 and serves to continuously or intermittently detect an acceleration of the motor 13 during the operation of the motor 13. The acceleration sensor 21 is preferably fastened to a circuit board of the rotary encoder 19, which is not visible in FIG. 1, however. Depending on the application, the acceleration sensor 21 is adapted and arranged to detect an acceleration that is radial, axial (for example, in the case of vibrations) or otherwise directed with respect to the axis of rotation 17. The acceleration sensor 21 can also be of a multi-axis design.

An electronic control unit 25, which is preferably accommodated in a housing 27 of the rotary encoder 19, is in connection with the acceleration sensor 21. Alternatively, the control unit 25 can also be provided externally from the rotary encoder 19.

FIG. 2 shows an exemplary development of the acceleration 26 detected by the acceleration sensor 21 in dependence on the time 28. A periodic pattern can be recognized in the development. It is caused by movement patterns of the machine arrangement 11 or of the motor shaft 15 and is generally referred to as a machine cycle 29. The starting point in time of the machine cycle 29 is in principle arbitrary, which is illustrated in FIG. 2 by the time-shifted machine cycle 29′.

The electronic control unit 25 (FIG. 1) is configured to automatically recognize the machine cycle 29, 29′ by analyzing the time development of the detected acceleration 26. To this end, the electronic control unit 25 applies an autocorrelation algorithm to the acquired acceleration data at least during the putting into operation of the machine arrangement 11. The machine cycle 29, 29′, including a defined starting point, is stored in a memory of the electronic control unit 25.

To recognize wear of the motor 13, for example a wearing down of the ball bearings, in good time, the electronic control unit 25 carries out a comparison of the detected acceleration 26 with a predefined threshold value 30. The previously automatically determined machine cycle 29, 29′ is considered in the comparison in that, on the one hand, the acceleration value is used at a specific point in time 32 within the machine cycle 29, 29′ and, on the other hand, a threshold value 30 corresponding to this point in time 32 is defined. Specifically, a threshold value 30 is defined that is higher by a wear allowance 33 than the value corresponding to this point in time 32 in the machine cycle 29, 29′.

When the threshold value 30 is exceeded by the currently detected acceleration, the electronic control unit 25 outputs a maintenance and/or warning signal. The operator of the plant can then arrange for a repair or a replacement of the motor 13 before a failure thereof results in an unwanted plant shutdown.

It is understood that a plurality of threshold values 30 can also be checked at different temporal positions of the machine cycle 29, 29′ to provide a more refined wear recognition. Furthermore, a plurality of acceleration directions can also be evaluated using a multi-axis acceleration sensor 21 and/or a plurality of acceleration sensors 21.

In addition to the maintenance and/or warning signal, the electronic control unit 25 can output information that relates to the automatically determined machine cycle 29, 29′, such as the length of the machine cycle 29, 29′ or the distribution of the values for the acceleration 26 within the machine cycle 29, 29′.

The acceleration sensor 21 does not necessarily have to be attached to the rotary encoder 19, but could also be attached to the stator of the motor 13. As an alternative to a linear acceleration sensor 21, a gyroscope could also be provided to detect the rotational acceleration of the motor shaft 15 and/or the stator.

The invention enables a reliable wear recognition of motors 13, while considering the machine cycle 29, 29′, without an active intervention by the operator being required.

### REFERENCE NUMERAL LIST

11 machine arrangement
13 motor
15 motor shaft
17 axis of rotation
19 rotary encoder
21 acceleration sensor
25 electronic control unit
26 acceleration
27 housing
28 time
29, 29′ machine cycle
30 threshold value
32 point in time
33 wear allowance

What is claimed is:

1-15. (canceled)

16. A sensor system for monitoring a motor that drives a machine arrangement via a rotating motor shaft, wherein a machine cycle is given by a periodic movement pattern of the machine arrangement and/or of the motor shaft and the sensor system comprises the following:
at least one acceleration sensor for continuously or intermittently detecting an acceleration of the motor; and
an electronic control unit that is in signal connection with the at least one acceleration sensor and that is configured, for a wear recognition, to carry out a comparison of the detected acceleration with at least one predefined threshold value and to consider the machine cycle in the comparison, wherein the electronic control unit is configured to automatically recognize the machine cycle based on a periodically occurring pattern in the time development of the detected acceleration of the motor.

17. The sensor system according to claim 16,
wherein the sensor system comprises a rotary encoder for continuously or intermittently detecting the angular position of the motor shaft.

18. The sensor system according to claim 17,
wherein the at least one acceleration sensor is fastened to a component of the rotary encoder.

19. The sensor system according to claim 17,
wherein the at least one acceleration sensor and the electronic control unit are integrated in the rotary encoder.

20. The sensor system according to claim 16,
wherein the electronic control unit is configured to carry out an autocorrelation of the time development of the detected acceleration for an automatic recognition of the machine cycle.

21. The sensor system according to claim 16,
wherein the electronic control unit is configured to store the machine cycle in a memory after the automatic recognition.

22. The sensor system according to claim 16,
wherein the electronic control unit is configured to output a maintenance and/or warning signal if the acceleration exceeds the at least one threshold value.

23. The sensor system according to claim 16,
wherein the electronic control unit is configured to define the at least one threshold value in dependence on the automatically recognized machine cycle.

24. The sensor system according to claim 16,
wherein the electronic control unit is configured to carry out the automatic recognition of the machine cycle repeatedly or continuously.

25. The sensor system according to claim 16,
wherein the electronic control unit is configured to recognize changes in the machine cycle over time.

26. The sensor system according to claim 16,
wherein the electronic control unit is configured to determine at least one piece of information relating to the machine cycle.

27. The sensor system according to claim 16,
wherein the electronic control unit is configured to associate the detected acceleration of the motor with a respective simultaneously detected angular position of the motor shaft.

28. The sensor system according to claim 16,
wherein the electronic control unit is configured to define a plurality of threshold values that are associated with respective points in time within the automatically detected machine cycle, and to carry out a separate comparison for each threshold value.

29. A method for monitoring a motor that drives a machine arrangement via a rotating motor shaft, wherein a machine cycle is given by a periodic movement pattern of the machine arrangement and/or of the motor shaft and, in the method,
by means of at least one acceleration sensor, an acceleration of the motor is continuously or intermittently detected, and
by means of an electronic control unit, which is in signal connection with the at least one acceleration sensor, a comparison of the detected acceleration with at least one predefined threshold value is carried out for a wear recognition and the machine cycle is considered in the comparison,
wherein the machine cycle is automatically recognized based on a periodically occurring pattern in the time development of the detected acceleration of the motor.

30. The sensor system according to claim 16,
wherein the angular position of the motor shaft is continuously or intermittently detected by means of a rotary encoder.

31. The method according to claim 29,
wherein the angular position of the motor shaft is continuously or intermittently detected by means of a rotary encoder.

32. The sensor system according to claim 23,
wherein the electronic control unit is configured to define the at least one threshold value in dependence on the automatically recognized machine cycle during the putting into operation of the sensor system.

33. The sensor system according to claim 26,
wherein the at least one piece of information relating to the machine cycle comprises the length of the machine cycle, the maximum acceleration within the machine cycle and/or the number of extreme values within the machine cycle.
